(19) United States
(12) Patent Application Publication
(10) Pub. No.: US 2006/0042864 A1
(43) Pub. Date: Mar. 2, 2006

(54) Steering assist mechanism

(76) Inventor: Stanford R. Ovshinsky, Bloomfield Hills, MI (US)

Correspondence Address: ENERGY CONVERSION DEVICES, INC., 2956 WATERVIEW DRIVE, ROCHESTER HILLS, MI, 48309, US

(21) Appl. No.: 10/925,290

(22) Filed: Aug. 24, 2004

(51) Int. Cl. B60K 17/344

(52) U.S. Cl. 180/447

(57) ABSTRACT

A steering assist mechanism for use in a vehicle having a steering linkage and an engine. The steering assist mechanism includes a driving unit having input and output ends. The output end being connected to the steering linkage. The steering assist mechanism also includes power take-off means adapted to connect the engine to the input end of the driving unit. The steering assist mechanism further includes an electromagnetic clutch in the driving unit between the input and output ends, and control means which are responsive to the torque exerted through the steering linkage to increase the energization of the clutch, whereby the steering linkage is driven by the power take-off means in a direction tending to reduce the torque.

### FIELD OF THE INVENTION

This invention relates to power steering devices, and more particularly to electrically controlled mechanisms for providing steering assistance to the driver of the vehicle. The power steering mechanism is of the type described in copending U.S. patent application to Stanford R. Ovshinsky, entitled “STEERING ASSIST MECHANISM”, filed concurrently herewith.

### SUMMARY OF THE INVENTION

It is an object of the present invention to provide an improved steering assist mechanism of the type generally shown in the aforementioned copending application and in which the source of power assistance is the engine of an automotive vehicle.

It is another object to provide an improved power steering mechanism of the above type which is highly sensitive and incorporates true torque-responsive principles, whereby the instantaneous power assistance is directly proportional to the amount of resistance met during directional changes.

It is also an object to provide an improve power steering apparatus of the above character which is not affected adversely by changes in engine speed of the vehicle during a steering operation.

It is a further object to provide an improved power steering arrangement as above described, in which a flexible shaft may be used if desired, thus greatly increasing the versatility of the unit.

It is also an object to provide a power steering unit of the above nature which does not affect the usability of the conventional manual steering control and which automatically disconnects the engine from the steering linkage when the engine is stopped, thus allowing free manual use of the steering apparatus.

It is another object to provide a power steering mechanism having the above characteristics, which minimizes the number of required mechanical parts such as gears, reduces the weight of the mechanism and mounts the parts so they are not unsprung, and which greatly reduces undesirable noise of the unit during operation.

Other objects, features, and advantages of the present invention will become apparent from the subsequent description, taken in conjunction with the accompanying drawings.

### BRIEF DESCRIPTION OF THE DRAWINGS

FIG. 1 is an elevational and partially schematic view of a suitable installation of the novel power steering apparatus in an automotive vehicle, showing the flexible power take-off shaft and the mounting of the driving unit on the steering shaft as well as the rheostat control and contact switch;

FIG. 2 is a plan view of a portion of the installation shown in FIG. 1, illustrating the supporting means for the flexible shaft and the disposition of the mechanism with respect to the vehicle engine;

FIG. 3 is a cross-sectional detailed view of the driving unit;

FIG. 4 is a cross-sectional view of a suitable rheostat installation and a resilient connection between the steering shaft and steering wheel;

FIG. 5 is a front view of the assembly shown in FIG. 4 with the cover removed showing the mounting of the rheostat;

FIG. 6 is a rear view of the assembly shown in FIG. 4, showing the construction of the resilient and lost-motion couplings; and

FIG. 7 is a plan view of a modified form of installation for the power steering unit, showing the versatility afforded by the flexible shaft.

### DETAILED DESCRIPTION OF THE INVENTION

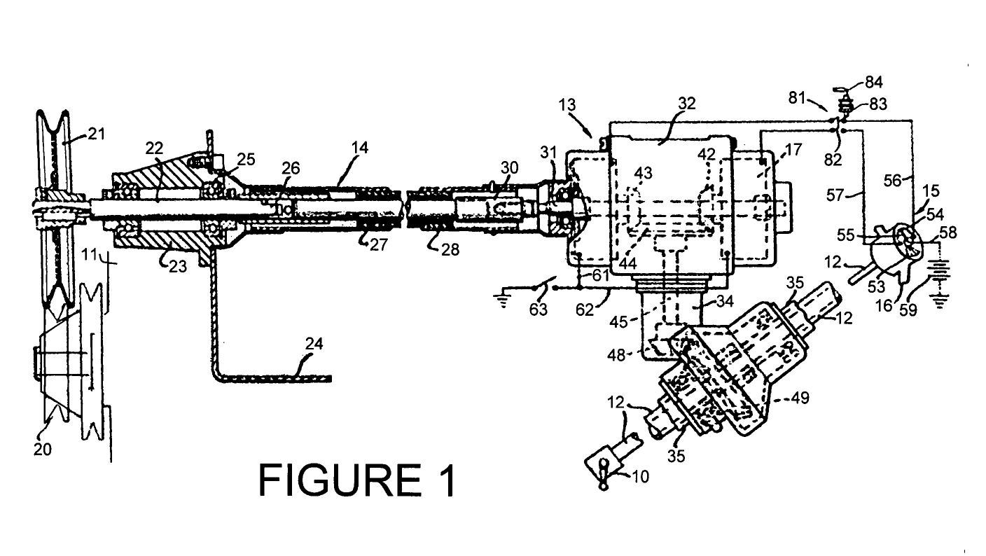

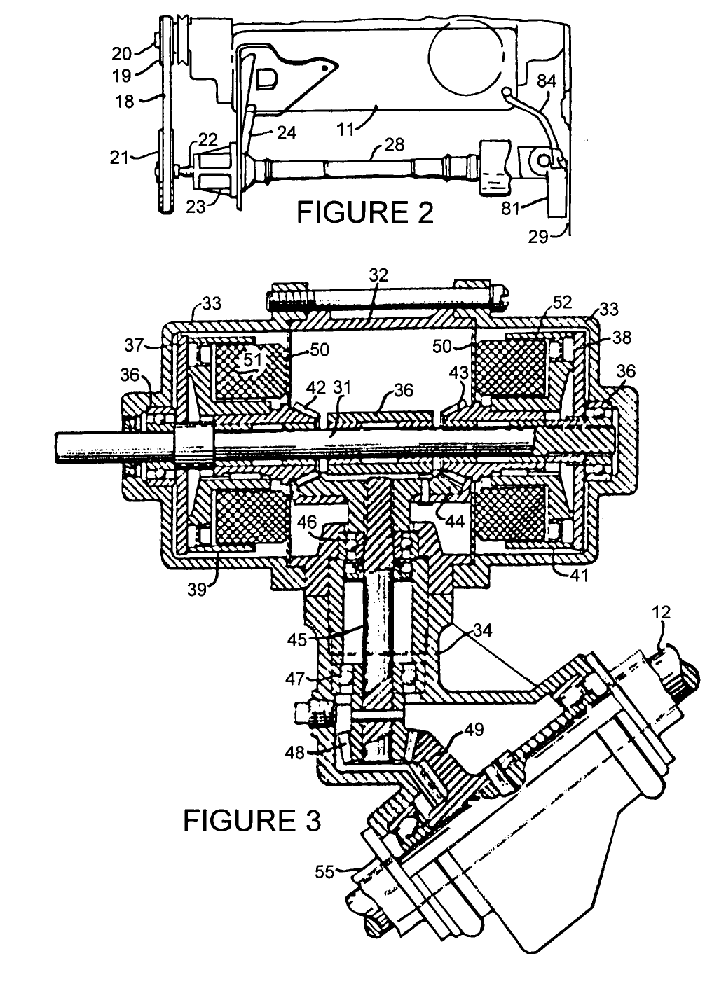

The power steering unit of this invention is of the same general type shown in FIG. 13 of the above-mentioned copending application and is used in cooperation with a conventional steering linkage having an actuating pitman arm 10. As shown in FIGS. 1 and 2 of the present application, the mechanism is adapted for use with an automotive vehicle having an engine 11 and a steering shaft 12 as part of the steering linkage. The mechanism comprises a driving unit generally indicated at 13 which is mounted on the steering shaft and which is supplied with power by a take-off from the engine crank-shaft, the take-off being generally indicated at 14. The power transferred by driving unit 13 from the engine crankshaft to steering shaft 12 is controlled by a rheostat mechanism generally indicated at 15 in FIG. 1. As described in detail in the aforementioned copending application, rheostat mechanism 15 measures the instantaneous torque differential between steering shaft 12 and steering wheel 16 held by the operator, this measurement being used to control the setting of electrically operated clutches 17 within driving unit 13 as described below.

FIGS. 1 and 2 show a suitable installation in a conventional automotive vehicle, while FIG. 7 shows a modified installation which demonstrates the versatility afforded by the novel power take-off construction. Referring to FIGS. 1 and 2, it will be seen that power take-off mechanism 14 includes a belt 18 extending between a pulley 19 on engine crankshaft 20 and a pulley 21 on a shaft 22. The latter shaft is supported by a bearing housing 23 which is secured to the side of engine 11 by means of a bracket 24. A pair of anti-friction bearings 25 are mounted within housing 23, and the opposite end of shaft 22 is connected by a coupling 26 to a flexible shaft 27. Shaft 27 is of any conventional type which allows full flexibility of direction, and this shaft is preferably enclosed by a housing 28. Flexible shaft 27 extends alongside engine 11 toward the fire wall 29 of the vehicle, and the rear end of shaft 27 is connected by a coupling 30 to input shaft 31 of driving unit 13. It will be noted that while flexible shaft 27 is shown as being substantially straight in FIGS. 1 and 2, it is possible to accommodate this shaft to various installations, as will become evident from the discussion of FIG. 7. If desired, coupling 26 may be of a slidable type to prevent unnecessary thrust forces from being transmitted by flexible shaft 27 to driving unit 13.

As shown in FIG. 3, driving unit 13 comprises a housing 32 having end portions 33, and this housing is mounted on steering shaft 12 by means of a bracket and gear housing 34 which is secured to the conventional stationary housing 35 for the steering shaft. Input shaft 31 extends through housing 32 and is rotatably supported by bearings 36 at either end and in the center. Clutches 17 comprise a pair of armatures 37 and 38 slidably but non-rotatably secured to shaft 31 in the housing ends, these armatures having surfaces adapted to cooperate with coacting friction surfaces on a pair of rotors 39 and 41. The latter members are keyed respectively to a pair of pinions 42 and 43 rotatably mounted an shaft 31. Gears 42 and 43 extend toward the central portion of the housing and mesh with opposite sides of an output gear 44, the axis of the latter gear being at right angles to the axis of shaft 31. A shaft 45 is keyed to output gear 44 and extends downwardly through bracket 34, being supported by bearings 46 and 47. The lower end of shaft 45 has a pinion 48 fixed thereto, this pinion meshing with a gear 49 secured to steering shaft 12. Walls 50 support coils 51 and 52 within housing end sections 33 and each coil serves to control its corresponding clutch. It will be seen that with coils 51 and 52 energized equally the forces on gear 44 will be equal but opposite and there will be no rotation of shaft 45 and no assistance to steering shaft 12. If however the energization of coil 51 predominates, the constant rotation of input shaft 31 will cause torque to be transmitted through armature 37 and rotor 39 to pinion 42 and thence to the steering shaft through gear 44, shaft 45, pinion 48 and gear 49. Likewise, increased energization of coil 52 over that of coil 51 will result in assistance to shaft 12 in the opposite direction. The amount of assistance to shaft 12 will be directly proportional to the degree of energization of the effective coil, which in turn is responsive to the instantaneous torque being applied by the operator.

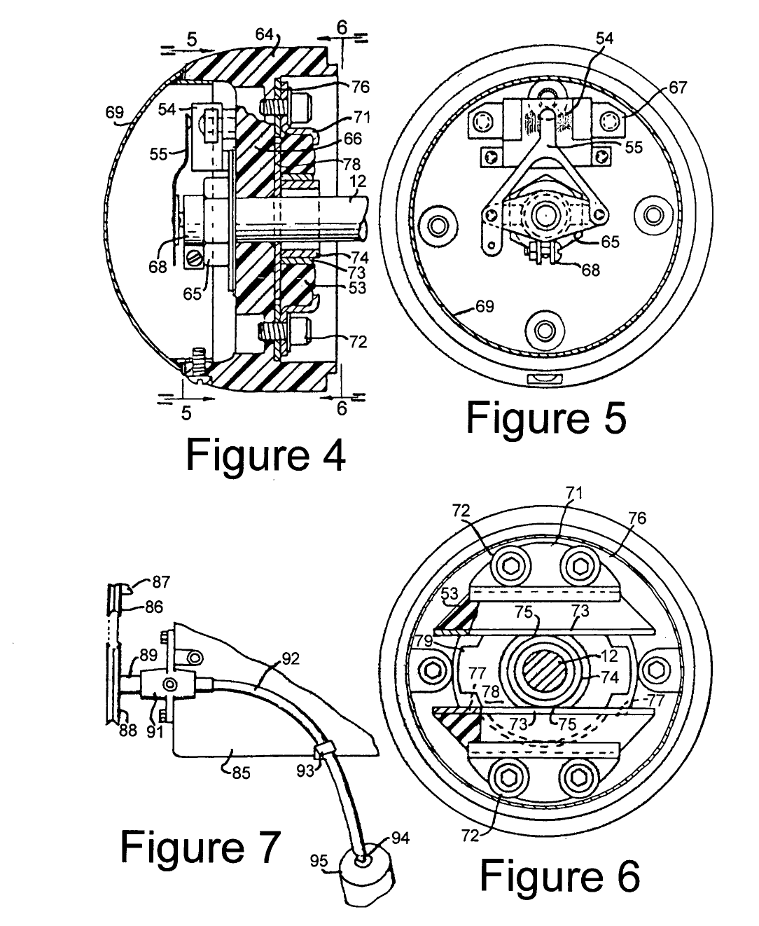

Rheostat mechanism 15 is shown schematically in FIG. 1 while FIGS. 4-6 shown a suitable construction of this mechanism. As shown schematically in FIG. 3 resilient coupling means 53 is disposed between steering Wheel 16 and steering shaft 12. This resilient coupling serves to transmit turning forces from the steering wheel to the steering shaft but permits limited movement of the wheel with respect to the shaft if there is resistance to turning. An angular shift of the steering wheel from its neutral position with respect to the shaft meets constantly increasing torque resistance from resilient coupling 53 as the angular shift increases. A wound wire rheostat 54 is fixed to steering wheel 16, and a contact arm 55 is foxed to steering shaft 12 and moves across rheostat 54. The opposite ends of the rheostat are connected to clutch coils 51 and 52 by conductors 56 and 57 respectively. Contact arm 55 is connected by a conductor 58 to a source of power 59 such as a vehicle battery. The opposite ends of clutch coils 51 and 52 are connected by conductors 61 and 62 respectively to ground through a manual on-an-off switch 63.

It will be seen that with no torque being exerted on steering wheel 16 the wheel will be in its neutral position with respect to steering shaft 12. Contact arm 55 will then be in its central position on rheostat 54 and clutch coils 51 and 52 will be equally but weakly energized. Upon a torque being exerted on steering wheel 16 due to road resistance resilient connection 53 will permit angular shifting of the steering wheel with respect to the steering shaft an amount dependent upon the torque exerted. Contact arm 55 will shift correspondingly on rheostat 54. One or the other of coils 51 and 52 will receive increased energization to drive the steering shaft in the manner described above. This power assistance will be in a direction to decrease the angular shift between the steering wheel and steering shaft and thus reduce or eliminate the original signal which caused the power assistance to take place. The device is thus a true closed-loop servomechanism which is torque-responsive in character.

FIGS. 4-6 illustrate a suitable construction for rheostat mechanism 15 and the resilient connection between the steering shaft and steering wheel. In these figures, 64 indicates the hub of steering wheel 16 which is held on steering shaft 12 by means of a nut 65 in a conventional manner. Hub 64 is provided with an intermediate wall 66, and rheostat 54 is secured to one side of wall 66 by means of a bracket 67. Contact arm 55 is secured to the end of steering shaft 12 by means of a bracket 68. The relative positions of rheostat 54 and contact arm 55 are such that the contact arm will sweep across the rheostat upon relative angular movement between the steering shaft and steering wheel. A cover plate 69 may be used to conceal these parts.

On the opposite side of hub wall 66 resilient means 53 is fastened by means of a pair of brackets 71 and bolts 72. This resilient means comprises a pair of blocks of rubber or similar resilient material which are fastened to hub wall 66 by means of brackets 71. Blocks 53 flare outwardly from the sides secured to hub wall 66, and the sides of the blocks facing steering shaft 12 have plates 73 fixed thereto. A cam 74 is fixed to steering shaft 12 between these plates and has flat portions 75 which engage the plates.

It will be seen that upon relative angular movement between steering shaft 12 and steering wheel 16, blocks 53 will yield with increasing resistance, cam surfaces 75 engaging plates 73 to compress the blocks. The amount of relative angular movement will of course depend upon the amount of torque exerted. A lost motion connection is provided between the steering wheel and steering shaft so that a positive drive is afforded to the steering shaft after a maximum torque is exceeded. This lost motion connection comprises a plate 76 fixed to hub wall 66 and having a pair of diametrically opposed notches 77. A member 78 is fixed to steering shaft 12 and has a pair of lugs 79 extending within notches 77. The relative sizes of notches 77 and lugs 79 are such that relative angular movement between the steering shaft and the steering wheel is permitted which is approximately equal to the maximum operative movement of contact arm 55 on rheostat 54. It will therefore be seen that a direct driving connection exists between the steering wheel and steering shaft, both through the resilient coupling means and through the lost motion positive connection. It should be kept in mind that since the amount of power assistance is proportional to the amount of distortion of the resilient coupling and is instantaneously applied; there is no noticeable looseness or backlash between the operator at the steering wheel and the steering linkage itself.

As mentioned previously, means are provided for automatically disconnecting engine 11 from the steering linkage when the engine is stopped, thus allowing free manual use of the steering apparatus. It will be seen that with the engine stopped input shaft 31 would be held stationary but that clutch coils 51 and 52 would ordinarily remain energized to some degree. The resultant connection between steering shaft 12 and input shaft 31 would increase the difficulty of turning steering shaft 12 manually. In the present embodiment, means are provided for automatically opening the circuits to clutch coils 51 and 52 when the engine is stopped, thus completely freeing steering shaft 12 from shaft 31. As shown in FIG. 1, this cutout means is indicated at 81 and comprises a switch 82 which is actuated by a bellows 83 responsive to oil pressure in the engine. This oil pressure operates bellows 83 through a connection 84, and with the engine running the pressure will be sufficient to close switch 82. However, reduction of oil pressure due to stopping of the engine will cause bellows 83 to open switch 82 and the clutch coil circuits. It will b appreciated that other types of cutouts, such as centrifugal, vacuum, voltage or mechanical types, could be used.

The operation of the embodiment shown in FIGS. 1-6 will be apparent from the foregoing description. With engine 11 running, input shaft 31 of driving unit 13 will be rotated by power take-off 14. Rheostat mechanism 15 will normally be held in its neutral position by resilient means 53, and clutch coils 51 and 52 will be equally but weakly energized. Upon the application of torque by the driver due to road resistance, one or the other of clutch coils 51 and 52 will receive increased energization, excitation of the other clutch coil being decreased accordingly. Power assistance will be transmitted to steering shaft 12 in a direction tending to centralize the rheostat mechanism.

Several of the important advantages of this steering arrangement, and particularly the rheostat and clutch control mechanism, are fully described in the above-mentioned copending application and need not be repeated. However, the particular construction shown in this application affords greatly improved results over previously known power steering mechanisms. The true torque-responsive nature of the system will for example be in no way affected by changes in engine speed during a steering assist operation. This is because the amount of power assistance at any given moment is determined by the position of contact arm 55 on rheostat 54, and this in turn is determined solely by the instantaneous torque exerted by the operator. With a specified energization of the clutch coils a predetermined amount of torque will be transmitted between the clutch faces. Should the rotational speed of the driving clutch member increase due to a rise in engine speed, the clutch slippage will become greater but the torque transmitted will not change appreciably as long as the clutch energization remains the same. Moreover, whatever change there is in torque transmission between the clutch faces will be immediately reflected in rheostat mechanism 15 through shifting of contact arm 55 on rheostat 54, and the clutch energization will be correspondingly adjusted. A stable system is thus achieved which preserves “road feel” at all times and gives the driver a positive sense of control.

The use of flexible shaft if desired in power take-off mechanism 14 and the reduction in the number and size of clutch and gear parts results in other advantages over previously known types of mechanical power steering mechanisms. In such previously known mechanism, mechanical friction type clutches have been employed, these clutches being actuated by cams or similar mechanical connections when torque is exerted on the steering wheel. A power take-off from the engine is used in these known mechanisms which are connected to the steering linkage by these mechanical friction type clutches to provide power assistance. In such arrangements it has been necessary to provide overrunning clutches or other drive release means between the power take-off and the mechanical friction type clutches. This is because the steering linkage must be left free for manual operation when the engine is stopped, and the friction type clutches would ordinarily hamper mechanical operation because they would always offer some frictional connection between the steering linkage and the stopped engine. It will be seen that this problem is similar to the one discussed above with respect to cutout means 81.

The necessity of using an overrunning clutch has prevented or at least greatly restricted the use of a flexible shaft in the power take-off of these previously known mechanisms. This becomes obvious when we consider that overrunning clutches or similar drive release means require an input with a fixed axis in order that the driving forces be equally distributed between the spaced torque transmitting parts of the overrunning clutch. If a flexible shaft were used as the input to an overrunning clutch, the continuous shifting of forces between the torque-transmitting parts of the clutch, due to the bent nature of the flexible shaft, and the subsequent unequal load concentration on the parts, would hamper the operation of the clutch.

In the present invention no overrunning clutch or similar part is necessary between the power take-off and the driving unit, since the clutches in the driving unit are electromagnetically operated. In other words, it is possible to disconnect the clutches in driving unit 13 by an electrical cutout switch such as that described above. The elimination of the need for an overrunning clutch permits the unrestricted use of a flexible shaft, and in particular a shaft directly connected to input shaft 31 of the driving unit.

The advantages of the use of a flexible shaft are illustrated in FIG. 7 which shows the general arrangement of an installation in which the flexible shaft has a substantial curvature. In this figure engine 85 of the vehicle is shown as having a pulley 86 fixed to the crankshaft 87 thereof. This pulley drives a pulley 88 fixed to a shaft 89 which is supported by a bearing bracket 91 secured to the engine block. A flexible shaft 92 is connected at one end to shaft 91 and extends in a curved fashion toward one side of the engine. The flexible shaft may be supported at an intermediate point by a bearing 93. The opposite end of flexible shaft 92 is connected to the input shaft 94 of a driving unit 95 which may be mounted on a steering shaft (not shown) of the vehicle. It will be seen from an examination of FIG. 7 that the axis of input shaft 94 is inclined substantially in both the vertical and horizontal directions with respect to the crankshaft 87. Such an installation could very easily by necessary in such vehicles as trucks, and would be impossible to obtain with the use of a rigid shaft in the power take-off mechanism. It is therefore seen that the use of electromagnetic clutches in the manner described imparts great versatility to the power take-off arrangement.

Reverting to the arrangement of the driving unit shown in FIG. 3, it will be seen that the electromagnetic clutches are placed on the high speed-low torque side of the unit. In other words, since the torque multiplication in the system occurs past the electromagnetic clutches (between pinions 42 and 43 and gear 44), the clutches need transmit relatively little torque. As a result, the sizes of the clutch parts may be made relatively small, thus taking up little space and reducing the noise possibilities. Moreover, due to the relatively small clutch parts the sensitivity of rheostat mechanism 15 is substantially greater than would otherwise be the case.

While it will be apparent that the preferred embodiments of the invention herein disclosed are well calculated to fulfill the objects above stated, it will be appreciated that the invention is susceptible to modification variation and change without departing from the proper scope.

I claim:

1. In a steering assist mechanism for use in a vehicle having a steering linkage and an engine, a driving unit having input and output ends, said output end being connected to the steering linkage, power take-off means adapted to connect said engine to the input end of said driving unit, an electromagnetic clutch in said driving unit between said input and output ends, and control means being responsive to torque exerted through said steering linkage to increase the energization of said clutch, whereby said steering linkage is driven by said power take-off means in a direction tending to reduce said torque.

2. In a steering assist mechanism for a vehicle having a steering linkage and an engine, a driving unit having input and output ends, means connecting the output end of said driving unit to said steering linkage, power take-off means adapted to connect said engine to the input end of said driving unit, said power take-off means including a flexible connection, a pair of oppositely rotating electromagnetic clutches in said driving unit between said input and output ends, a mechanism for controlling the relative energization of said clutches, said control mechanism being responsive to torque created in said steering linkage to increase the energization of that clutch which will urge said steering linkage in a direction reducing said torque, circuit connections between said control mechanism and said clutches, a switch in said circuit connections movable between a first position closing said connections and a second position opening said connections, and means responsive to the stopping of said engine for moving said switch to its second position.

3. The combination according to claim 2, said mean responsive to stopping of the engine comprising a pressure responsive switch actuator, and means adapted to connect said actuator to the oil system of said engine, whereby a reduction in oil pressure will cause said actuator to move said switch to its second position.

4. In a steering assist mechanism for a vehicle of the type having a steering linkage in an engine, a driving unit having input and output ends, means connecting the output end of said driving unit to said steering linkage, power take-off means adapted to connect said vehicle engine to the input end of said driving unit, a pair of oppositely rotating electromagnetic clutches in said driving unit between said input and output ends, means for controlling the energization of said electromagnetic clutches, said control means including a rheostat and a contact arm mounted on relatively movable portions of said steering linkage, said contact arm being movable from a central position on said rheostat in either direction responsive to relative movement between said portion of the steering linkage, and circuit connections between said rheostat and contact arm and said clutches, whereby said clutches are equally but weakly energized when said contact arm is in said central position, movement of said contact arm from said central position causing increased energization of that clutch which will urge said contact arm toward its central position.

5. The combination according to claim 4, said steering linkage including a steering wheel and a steering shaft, said wheel and shaft being relatively rotatable, said contact arm and rheostat being connected between said steering wheel and steering shaft.

6. The combination according to claim 5, further provided with a resilient connection between said steering wheel and steering shaft, said resilient connection offering increased resistance as the angular movement between said steering wheel and steering shaft increases.

7. The combination according to claim 6, said resilient connection comprising a pair of rubber blocks secured to said steering wheel on opposite sides of said steering shaft, a pair of plates carried by said blocks and facing each other, and oppositely disposed flat surfaces on said steering shaft engaging said plates.

13. In a steering assist mechanism for a vehicle of the type having a steering wheel, a steering shaft and an engine, a driving unit mounted on said steering shaft, said driving unit having an input shaft and an output shaft, means connecting said output shaft to said steering shaft, power take-off means including a flexible shaft adapted to be driven by said engine and connected to said driving unit input shaft, a pair of electromagnetic clutches between said input and output shafts, reduction gearing between said electromagnetic clutches and said output shaft, means for controlling said electromagnetic clutches, said control means including a contact arm and rheostat connected between said steering wheel and steering shaft, said contact arm being movable from a central position on said rheostat in either direction responsive to relative movement between said steering wheel and steering shaft, resilient means connecting said steering wheel and steering shaft, said resilient means offering increased resistance as the angular movement between said steering wheel and steering shaft increases, circuit connections between said rheostat and contact arm and said electromagnetic clutches, said clutches being equally but weakly energized when said contact arm is in its central position, movement of the contact arm from its central position causing increased energization of that clutch which will urge the contact arm back toward its central position, a cutout switch in said circuit connections movable between open and closed positions, and means responsive to stopping of said engine for moving said cutout switch into its open position.
